(19) United States
(12) Patent Application Publication
(10) Pub. No.: US 2007/0273656 A1
(43) Pub. Date: Nov. 29, 2007

(54) Modular keyboard for an electronic device and method operating same

(75) Inventors: Jackson Chang, Shanghai (CN); David Ho, Shanghai (CN); Wei Shen, Shanghai (CN); Kaiwu Li, Shanghai (CN)

Correspondence Address: PAUL, HASTINGS, JANOFSKY & WALKER LLP, P.O. BOX 919092, SAN DIEGO, CA, 92191-9092, US

(73) Assignee: INVENTEC APPLIANCES (SHANGHAI) CO., LTD.

(21) Appl. No.: 11/653,361

(22) Filed: Jan. 16, 2007

(30) Foreign Application Priority Data
May 25, 2006 (CN) 2006/10026873.5

(51) Int. Cl. G09G 5/00

(52) U.S. Cl. 345/169

(57) ABSTRACT

A modular keyboard configured for an electronic device having a mechanical portion and a virtual portion. One of the two portions is an alphanumeric keypad and the other portion is a navigation keypad. The alphanumeric keypad is preferably arranged on a lower portion of the body of the electronic device. The virtual keypad is implemented by software and displayed on a touch screen of the electronic device. In one input mode of the electronic device, only a subset of keys the mechanical portion of the modular keyboard is enabled. In another input mode, all keys of the mechanical portion of the keyboard are enabled. In still another input mode, both the mechanical portion and the virtual portion of the modular keyboard are enabled.

### FIELD OF THE INVENTION

The present invention relates generally to a modular keyboard having a mechanical portion and a virtual portion. Preferred embodiments of the invention can be configured for use in electronic devices, including cell phones and the like.

### BACKGROUND OF THE INVENTION

Typical keyboards of portable electronic devices, such as cell phone, PDA, etc., can be divided into two categories. The first category of typical keyboards is one which has a traditional design, such as that shown in FIGS. 1 and 2. The traditional designs shown in FIGS. 1 and 2 are currently the most popular keyboards for cell phones. The second category keyboard is shown in FIG. 3.

The keyboard 110 for electronic device 100 that is shown in FIG. 1 includes a navigating device 111, one or more shortcut keys 112, and a numeric pad 113. The keyboard 210 for electronic device 200 that is shown in FIG. 2 includes a navigation keypad 211, one or more shortcut keys 212, and a QWERTY type keypad 214. While these typical keyboards are functional, there are limitations associated with them. For example, these typical keyboards employ mechanical keys or buttons, and these keys/buttons occupy a significant portion of the main body of the electronic device. As a result, the electronic device may be larger than users like, or the display for the electronic device may have to be smaller.

A conventional keyboard for the second category is shown in FIG. 3. The keyboard 310 for electronic device 300 shown in FIG. 3 includes a navigation keypad 31 1, one or more shortcut keys 312, and an alphanumeric keypad 315. Like those shown in FIGS. 1 and 2, the navigating device 311 and shortcut keys 312 are mechanical keys that are arranged on a lower portion of the main body of an electronic device. The alphanumeric keypad 315 is implemented with a touch screen 316. Accordingly, the alphanumeric keypad 315 may be considered to be a virtual keyboard.

More particularly, the virtual keyboard 315 is driven by software and implemented on touch screen 316. The touch screen 316 therefore provides at least two functions: displaying information (the traditional function) and receiving information from a user (virtual keyboard 315). Although the virtual keyboard 315 saves some area for the electronic device 300 when compared to the electronic devices 100 and 200, the input operation must still be accomplished by a stylus for operating the interfaces as shown in FIG. 3. Such disadvantage complicates the operating procedure, and input operation with a finger of a user is not possible.

### SUMMARY OF THE INVENTION

It is an object of the present invention to provide a modular keyboard for electronic devices, which not only increases the area of the display screen but also realizes single-hand operation. Additional objects of the invention are evident in the description below.

The preferred embodiment of the invention is a modular keyboard that is configured for use with an electronic device. For example, the modular keyboard may be configured for use on a cell phone, PDA, and the like. The modular keyboard includes a mechanical portion and a virtual portion. The mechanical portion is configured to be disposed on a body of the electronic device. The virtual portion is configured to be implemented by software and displayed on a touch screen of the electronic device.

One of the two portions of the modular keyboard is an alphanumeric keypad and the other portion is a navigation keypad. For example, in the preferred embodiment shown in FIG. 5, the mechanical portion is an alphanumeric keypad while the virtual portion is a navigation portion. In another embodiment, the mechanical portion can be configured to be a navigation keypad and the virtual portion may be configured to be an alphanumeric keypad.

Preferably, an indicating lamp, e.g., an LED, is associated with each key of the mechanical portion of modular keyboard. In addition, a subset of the mechanical portion can be assigned navigational functions. For example, keys associated with numbers 2, 4, 6 and 8 may be assigned upward, leftward, rightward, and downward movements, respectively.

Depending on the input mode of the electronic device, some or all keys of the mechanical portion are enabled or activated. Available keys are indicated by illumination of the indicating lamps. The virtual portion of the modular keypad is shown on the touch screen depending on the input modes. For example, in an input mode in which only navigational function are needed, only the subset of keys of the mechanical portion are enabled, and the virtual portion is deactivated, thereby providing maximum space on the touch screen. In another input mode in which both navigational and alphanumeric inputs are required, all keys of the mechanical portion are enabled, and the virtual portion is displayed.

### BRIEF DESCRIPTION OF THE DRAWINGS

FIG. 1 is a schematic drawing of a prior art electronic device, which includes a navigating keypad and a numeric keypad.

FIG. 2 is a schematic drawing of another prior art electronic device, which includes a navigation keypad and an alphanumeric QWERTY type keypad.

FIG. 3 is a schematic drawing of still another prior art electronic device, which includes a navigation keypad device and a virtual alphanumeric keypad.

FIG. 4 is a schematic drawing of an electronic device (e.g., a cell phone) in which a preferred embodiment of the modular keyboard of the present invention is implemented.

FIG. 5 is a schematic drawing of the electronic device shown in FIG. 4, in which both the mechanical portion and the virtual portion of the modular keyboard are illustrated.

FIG. 6 shows an exemplary flowchart for a preferred input method of the present invention.

### DESCRIPTION OF THE PREFERRED EMBODIMENTS

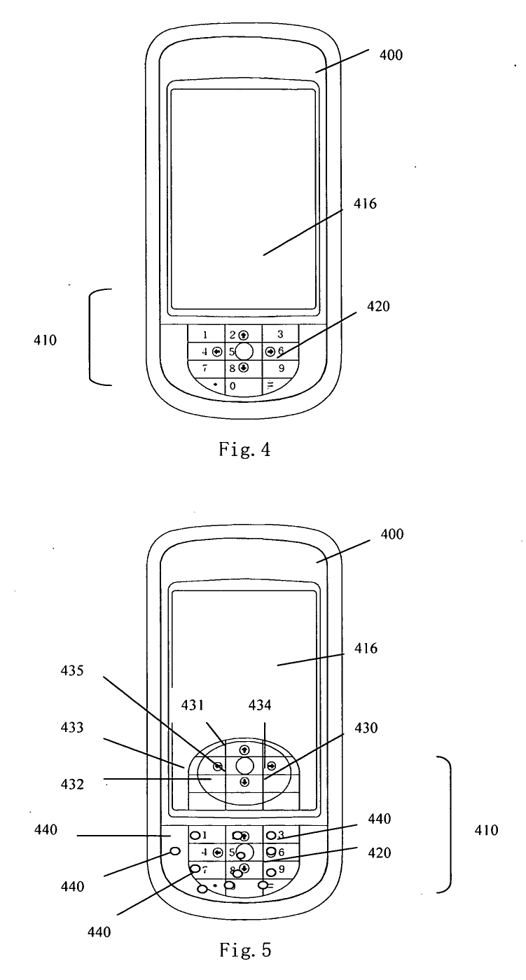

FIG. 4 is a schematic drawing of an electronic device 400 (e.g., a cell phone) according to a preferred embodiment of the present invention, in which only the mechanical portion 420 of the modular keyboard 410 is activated and illustrated. FIG. 5 is a schematic drawing of the electronic device 400, in which both the mechanical portion 420 and the virtual portion 430 of the modular keyboard 410 are activated and illustrated. Note that although a cell phone is shown as the preferred embodiment, the present invention can be adapted or otherwise configured for use in other electronic devices, including, e.g., a PDA, pocket PC, and the like.

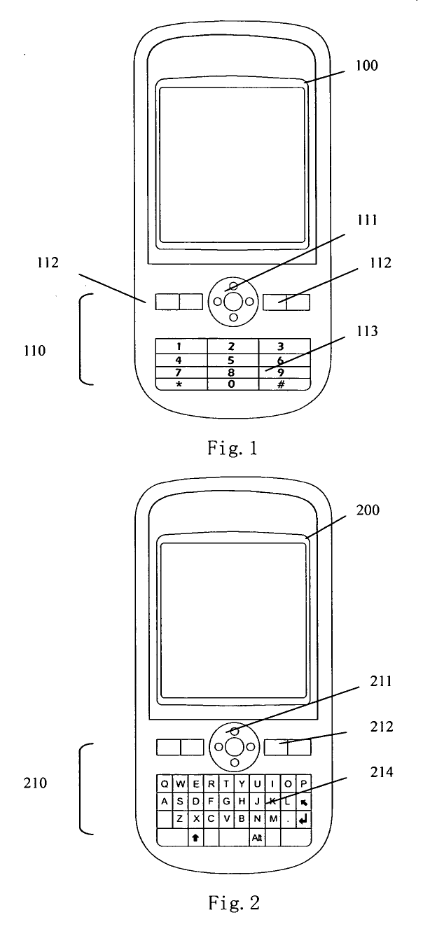

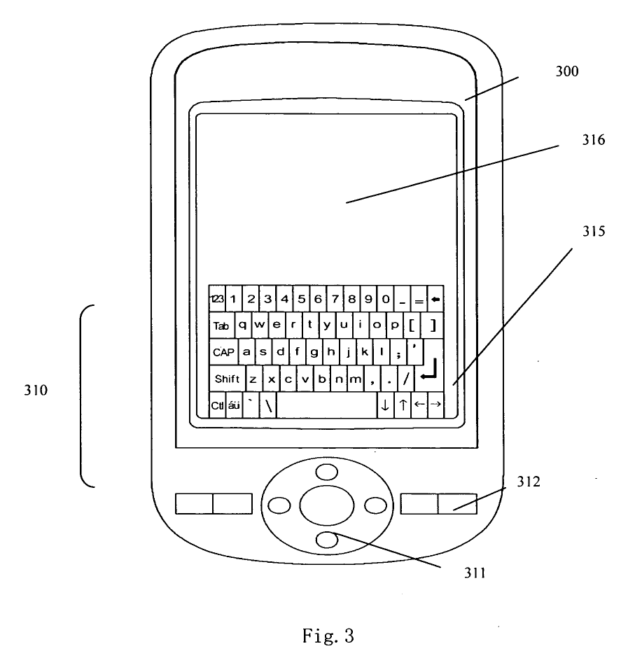

The modular keyboard 410 shown in FIGS. 4 and 5 is configured for an electronic device such as a cell phone. In this preferred embodiment, the modular keyboard 410 includes mechanical portion 420 (in this case, an alphanumeric keypad) and the virtual portion 430 (in this case, a navigation keypad). In other embodiments, other keypads may be present. In still other embodiment, the alphanumeric keypad may be configured to be the virtual portion 430, and the navigation keypad may be configured to be the mechanical portion 420. It should be noted other modifications are possible according to practical requirements. For example, more keys can be added to provide the function of the shortcut keys, such as those shown in FIGS. 1-3. Alternatively, the shortcut keys can be assigned to selected key in the alphanumeric keypad. Furthermore, the alphanumeric keypad can be a standard keyboard. The term “standard keypad” means that the layout of keys complies with the industrial standard, such as telephone standard keyboard (CCITT) or letter input keyboard (QWERTY). Also, the implementation of the virtual portion 430 can be varied depending on user preferences.

Preferably, the virtual portion 430 is implemented on touch screen 416, and the mechanical portion 420 is physically provided on a casing of the electronic device 400. As shown in FIG. 5, the mechanical portion 420 is an alphanumeric keypad and the virtual portion 430 is a navigation keypad. In another embodiment, the mechanical portion 420 can be configured to be the navigation keypad and the virtual portion 430 can be configured to be the alphanumeric keypad.

In any event, a subset of keys on the alphanumeric keypad can be further assigned with navigational functions. For example, in the exemplary embodiment shown in FIG. 5, keys 2, 4, 6, and 8 of the alphanumeric keypad are assigned with upward, leftward, rightward, and downward movements, respectively. In addition, key 5 is assigned with “OK” function, which may, for example, represent selection of a choice. In this manner, the alphanumeric keypad can be fully exploited and the usability of the touch screen 416 is enhanced.

Preferably, an indicating lamp 440 is provided below each key of the alphanumeric keypad, in this case, the mechanical portion 420. The indicating lamps 440 can be implemented, e.g., by using LED's (Light-Emitting Diodes). This implementation of the invention is different from any prior art keyboard that has only one or several indicating lamps for the whole keyboard. The provision of at least one LED for each key facilitates selecting the required key in the input method of the present invention and for identifying the certain keys used in navigation function. In another embodiment in which the alphanumeric keypad is implemented as the virtual keypad 430, modification can be made to highlight the subset of keys by using different means, including, for example, different colors on the keypad or different light intensities.

Moreover, the navigation keypad can be configured with fewer keys. For example, the navigation keypad 430 of FIG. 5 can be limited to just five keys, including an upward key 431, a downward key 432, a leftward key 433, a rightward key 434, and an “OK” key 435. In this manner, the navigation keypad would occupy a smaller area of the display screen 416. Also, in this manner, each key of the navigation keypad device 430 can be provided with a larger area on the display screen 416, which enables a user to use his or her finger (in lieu of a stylus) to operate the keys. The advantage of this embodiment of the invention is clear. The user of electronic device 400 can operate it using a single-hand operation rather than using two hands (one holding the device and the other using a stylus).

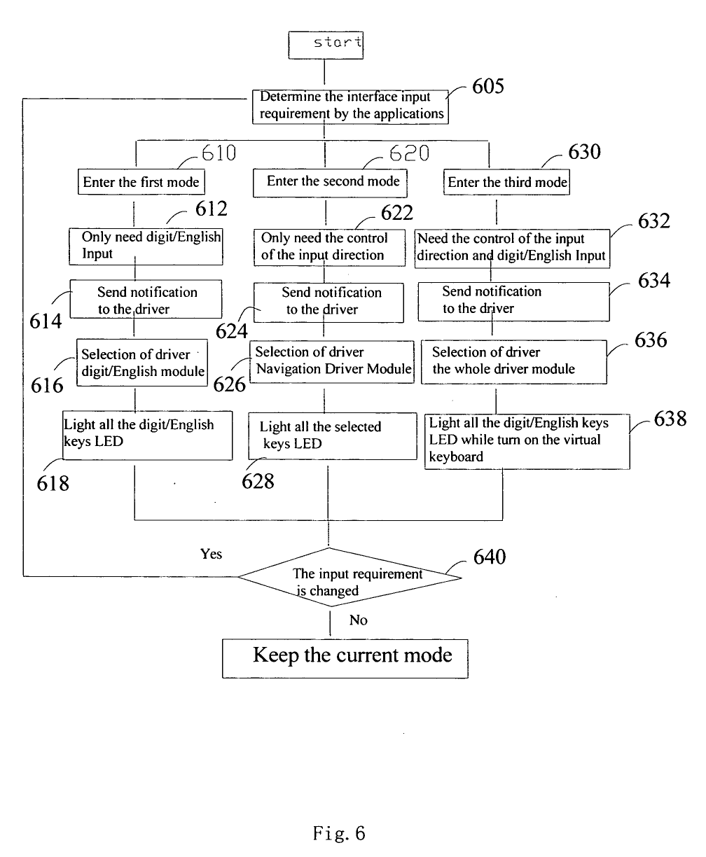

FIG. 6 shows an exemplary flowchart for a preferred input method of the present invention. In this embodiment, operation of a modular keyboard of the present invention, e.g., keyboard 430 shown on FIG. 5, is associated with three operation modes. In other embodiment, fewer or more modes may be included.

In step 605, the electronic device (such as a smart phone) implemented with the input method of the invention enters into one of three modes according to the input requirement. For example, in the first mode 610, in which only number and/or letter input operation is required for input interface; steps 612 through 618 are executed. In the second mode 620, in which only navigation operation is required to achieve direction control for input interface, steps 622 through 628 are executed. In the third mode 630, in which both navigation and number and/or letter input operation are required at the same time, steps 632 through 638 are executed.

In the first mode 610, the requirement for the input interface of the electronic product includes only alphanumeric input function in step 612. In step 614, the application software of the electronic product sends commands to the driver software. In step 616, the driver software selects the entire driving module of the alphanumeric keypad (e.g., alphanumeric keypad 420). In step 618, the electronic device illuminates all the indicating lamps on the alphanumeric keypad. Then, a user of the electronic device can accomplish the input operation of number or letter by pressing down one or more of the keys on the alphanumeric keypad.

In the second mode 620, the current requirement for the input interface includes only direction control, e.g., direction control in game application, in step 622. In step 624, the application software of the electronic device sends commands to the driver software. In step 626, the driver software selects the navigation driving module of the alphanumeric keypad. In step 628, the electronic device illuminates the indicating lamps of associated with specified keys that correspond with the navigation driving module. In the embodiment shown in FIG. 4, keys 2, 4, 5, 6, and 8 are assigned as upward, leftward, “OK”, rightward, and downward, respectively. In this way, the user can press down the required key on the alphanumeric keypad to achieve the operations of direction control or browsing.

In the third mode 630, the current requirement for the input interface needs both alphanumeric input and direction control, such as the tasks of editing messages and inputting telephone number etc., in step 632. In step 634, the application software of the electronic device sends the command to the driver software. In step 636, the driver software selects the entire driving module of the alphanumeric keypad and the driving module of the virtual keypad. In step 638, the electronic device not only illuminates all the keys of the alphanumeric keypad, but also shows the virtual keypad. In the preferred embodiment shown in FIG. 5, both mechanical keypad 420 and virtual navigation keypad 430 on the touch screen 416 are functional.

For example, when dialing a telephone number, user requires all ten of the numbered keys (0, 1, 2, etc.) in the alphanumeric keypad. In this operation mode, the electronic device activates and illuminates 10 keys on the alphanumeric keypad. When selecting music and videos, however, the user requires only navigation function, then the electronic device can activate only five keys (e.g., keys 2, 4, 5, 7 and 8) in the alphanumeric keypad. When editing message, user needs both alphanumeric keypad and the navigation keypad, the electronic device activates both mechanical and virtual keypads at the same time.

When the user selects and enters one input mode, the electronic device sets the input interface accordingly. In other words, the input interface provided by the electronic device corresponds with a specific input mode. For example, when the user requires both the navigation and alphanumeric input at the same time, the virtual keypad 430 shows up in the touch screen 416. When the user requires only navigation, the electronic device illuminates only the certain keys selected in the alphanumeric keypad. Preferably, the key layout of the navigation keypad is the same as the subset of keys associated with navigational function of the alphanumeric keypad.

Preferably, the mechanical portion is located at a lower portion of the body of the electronic device, while the virtual portion, when displayed, is located at a lower portion of the touch screen near the mechanical portion. In the exemplary embodiment shown in FIG. 5, when the operation mode of the keyboard are switched, it would appear that the navigation keypad 430 is folded down along the borderline of the navigation keypad 430 and the alphanumeric keypad 420 to overlap with the alphanumeric keypad 420. In other words, it would appear that the navigation keypad 430 seems to be hidden into the alphanumeric keypad. In this way, the present invention can hide or pop up the navigation keypad, and bring an aesthetic sense of a partly hidden and partly visible navigation keypad.

After one of steps 618, 628, and 638, the process goes to step 640, in which a determination is made regarding whether the input requirement has changed. If so, the process returns to step 605 and re-selects an appropriate input mode, which is one of first mode 610, second mode 620, and third mode 630. Otherwise, the process keeps the current mode.

In preferred embodiments of the invention, icons or legends for indicating the input mode can be displayed on the touch screen of the electronic device. In this manner, the operation mode of the keyboard can be more easily identified by a user of the electronic device.

Although the present invention has been described with referenced to a preferred embodiment, it will be appreciated by those skilled in the art that various modifications, alternations, variations, and substitutions of parts and components may be made without departing from the spirit and scope of the invention. Therefore, the present application is intended to cover such modifications, alternations, variations, and substitutions of parts and components.

What is claim is:

1. A modular keyboard, comprising:
a mechanical portion configured to be disposed on a body of an electronic device; and
a virtual portion configured to be shown on a touch screen of the electronic device;
wherein one of the portions is an alphanumeric keypad and the other portion is a navigation keypad;
wherein the virtual portion is shown on the touch screen only when the electronic device enters into a specific mode.

2. The modular keyboard of claim 1, wherein the mechanical portion is located at a lower portion of the body of the electronic device, and the virtual portion is located at a lower portion of the touch screen of the electronic device.

3. The modular keyboard of claim 1, wherein an indicating lamp is associated with each key of the mechanical portion.

4. The modular keyboard of claim 1, wherein the alphanumeric keypad is a CCITT keypad, QWERTY keypad.

5. The modular keyboard of claim 1, wherein the alphanumeric keypad includes one or more keys that are assigned with navigational function.

6. The modular keyboard of claim 5, wherein the one or more keys are associated with 2, 4, 5, 6, and 8 on the alphanumeric keypad.

7. The modular keyboard of claim 6, where the 2, 4, 6, and 8 keys on the alphanumeric keypad are associated with upward, leftward, rightward and downward movement, respectively.

8. A method for operating an electronic device having a modular keyboard comprising a mechanical portion and a virtual portion, comprising:
determining an input mode for an input interface of the electronic device;
enabling a subset of keys of the mechanical portion of the modular keyboard when a first input mode is required for the input interface;
enabling all keys of the mechanical portion of the modular keyboard when a second input mode is required for the input interface; and
enabling both the mechanical portion and the virtual portion of modular keyboard when a third input mode is required for the input interface.

9. The method of claim 8, wherein the first mode is one in which only navigational function is required.

10. The method of claim 8, wherein the second mode is one in which alphanumeric input is required.

11. The method of claim 8, wherein the third mode is one in which both alphanumeric input and navigational function are required.

12. The method of claim 8, further comprising providing an indicating lamp for each enabled key of the mechanical portion of the modular keyboard.

13. The method of claim 8, further comprising displaying the virtual portion of the modular keyboard on a touch screen of the electronic device.

14. The method of claim 13, further comprising displaying an indication of the input mode on the touch screen of the electronic device.

15. The method of claim 14, wherein the indication is one of three icons associated with the input modes.

16. An electronic device having a plurality of input modes, comprising:
a body;
a touch screen disposed on an upper portion of the body; and
a modular keyboard having a mechanical portion and a virtual portion, the mechanical portion is disposed on a lower portion of the body and the virtual portion is disposed on the touch screen;
wherein one or more of the mechanical portion and the virtual portion of the modular keyboard are enabled depending on which of the plurality of input modes is required.

17. The electronic device of claim 16, further comprising an indicating lamp for each key of the mechanical portion of the modular keyboard.

18. The electronic device of claim 16, wherein a subset of keys of the mechanical portion of the modular keyboard is associated with navigational function.

19. The electronic device of claim 18, wherein the subset of keys includes the 2, 8, 4, and 6 keys, which are assigned with an upward motion, a downward motion, a leftward motion, and a rightward movement, respectively.

20. The electronic device of claim 18, wherein layout of the subset of keys of the mechanical portion of the modular keyboard is the same as layout of the virtual portion of the modular keyboard.
